(19) United States
(12) Patent Application Publication
(10) Pub. No.: US 2004/0025539 A1
(43) Pub. Date: Feb. 12, 2004

(54) Method and device for cutting glass tubes

(76) Inventors: Erich Fischer, Mitterteich (DE); Alexander Hummer, Arzberg (DE); Volker Trinks, Mitterteich (DE); Rupert Fehr, Mitterteich (DE); Alfons Wolfrum, Trischenreuth (DE); Markus Reindl, Mitterteich (DE); Gottfried Haas, Tirschenreuth (DE); Andre Witzmann, Waldershof (DE); Ulla Trinks, Mitterteich (DE); Hubertus Kramer, Mitterteich (DE); Klaus Rustler, Tirschreuth (DE)

Correspondence Address: MERCHANT & GOULD PC, P.O. BOX 2903, MINNEAPOLIS, MN, 55402-0903, US

(21) Appl. No.: 10/381,073

(22) PCT Filed: Jul. 31, 2001
(86) PCT No.: PCT/EP01/08833

(30) Foreign Application Priority Data
Sep. 27, 2000 (DE) 100 47 850.6

(51) Int. Cl. C03B 21/00; C03B 21/06

(52) U.S. Cl. 65/105; 65/108

(57) ABSTRACT

The invention relates to a method for cutting glass tubes, characterised by the following steps: a glass strand is drawn; a heating device is driven synchronously with the glass strand and is directed towards the region of a desired separation point; the glass strand is drawn in the region of the desired separation point; a separation device is driven synchronously with the glass strand; the separation device is actuated in such a way that it severs the glass strand at the desired separation point.

The invention relates to a method and an apparatus for producing tube sections made of continuous glass strands.

It is known to produce glass strands in a continuous drawing or re-drawing process and to break them down into individual sections by breaking. The glass tube thus obtained is used for general technical or pharmaceutical purposes. An important requirement to be fulfilled by such glass tubes is that they are shatterproof.

Numerous publications have become known which provide proposals for severing such glass tubes from a glass strand or drawn tube. Such an apparatus is described in DE 1 264 363. However, the apparatus is very complex and not flexible.

It is known to sever glass tubes in the continuously drawn tube by burning off through thermal shock. In this process, a cutter such as a cooled metal part is provided downstream of a drawing machine. The cutter moves over the still hot glass tube surface and produces a first fracture. The tube is broken off by applying a bending moment. The tube ends are more or loss provided with splinters which impair further processing.

A splinter-free separation of the glass tubes can be achieved by the so-called thermally softened separation. The following method steps are applied in detail:

a) Heating of the glass tube until the processing temperature (approx. 1000° C.) is reached.

b) Subsequent deformation with shaping tools or by injecting gases.

c) Drawing off the heated zone.

It is also known to provide a separation process after the drawing.

DE 4 036 629 and U.S. Pat. No. 3,188,191 each describe a ring burner. According to U.S. Pat. No. 3,188,191, the ring burner is used for heating a narrow region of the glass tube as well as for fire polishing the ends of the glass tube after the drawing. The method is discontinuous. It can be used for separating tubes of large diameters.

SU 996 048 describes the separation of glass tubes by means of a ring burner. Closed tube ends are produced after the drawing. Further relevant specifications are U.S. Pat. No. 5,280,130, U.S. Pat. No. 4,146,380, U.S. Pat. No. 4,913,719, U.S. Pat. No. 4,273,993, U.S. Pat. No. 5,240,066.

The deformation of the heated zone occurs in many cases with shaping tools in order to produce a defined shape (orifices, neck regions, shoulders, profiles, etc.). The deformation is often supported by the injection of gases (lamp production) and is combined with coatings or pressing processes.

In most cases the drawing of the heated region is used to achieve a defined shape of the sections without severing the sections directly in a thermally softened fashion. Mostly, this is followed by another severing process. According to U.S. Pat. No. 4,885,945 glass tube regions are heated for the production of micropipettes and thereafter drawn up to a tip. According to U.S. Pat. No. 4,675,043 a method is described for the production of ink-jet printers in order to provide tube sections with the required dimensions only by defined heating and drawing. It is also known to follow up the heating source during the drawing, so that the hottest zone is always situated centrally in the heated region (cf. U.S. Pat. No. 4,818,266 and U.S. Pat. No. 4,828,599).

If severing is performed after the drawing, there are different possibilities for forming the ends depending on the product requirements. On the one hand, the severing is not performed in a thermally softened fashion, on the other hand one can obtain open or closed ends in thermally softened severing. Methods are known for producing ampoules and small bottles in which a floor and an open end are obtained (cf. DE 1 961 2265 for example).

It is described in U.S. Pat. No. 2,215,980 how glass articles (blow caps) are severed in such a way that the glass tube is heated at the separation point with moved burners until the processing temperature is reached and is therefore drawn off. Then, oxygen is withdrawn from the burner. Air is blown into the glass tube, so that the drawn zone is cooled. At the edge of the drawn zone, heating is applied again (separating burners—more supply of oxygen) until the severing. The burner is still used for preheating the edge. A blow cap separation according to a similar method but with laser heating is described in U.S. Pat. No. 4,682,003. U.S. Pat. No. 3,597,182 describes the shaping of a floor in a non-circular cross section by thermally softened separation.

According to U.S. Pat. No. 4,146,380 a laser is used for heating an already drawn region. It acts up to the separation. A defocused laser beam is used for preheating.

DE 3 744 369 describes a burner arrangement and follow-up device in which the tube is locally heated up to the processing temperature. Rollers pull said zone downwardly. The tube is rotated about its longitudinal axis. Molten tube floors are obtained as a result. In addition to the gas/air or oxygen burners, electric power is supplied by means of electrodes (an arc is produced on the front and rear side of the tube, so that the tube is heated evenly over the circumference. Prior to closing the tube a hole is burnt by means of a hole burner into the tube. Severing tools such as knives or shears are preferably only used for severing (shearing cutting) from highly viscous glass strands or drops that come from the glass melt (DE 1 962 282).

According to GB 1 264 363, the production of enclosed glass tubes is described for the pharmaceutical industry by thermally softened separation after the drawing machine. In this process, a region of the tube is heated by a number of mechanically synchronously entrained burners, severed and removed with a speed which is higher than that of the drawing machine.

All these known apparatuses or methods for cutting glass tubes to length from a continuous tube strand are unsatisfactory. They are either unsuitable for producing splinter-free ends or they are complex, inflexible or unsuitable for continuous operation.

The invention is based on the object of providing a method and an apparatus with which glass tubes can be severed from a continuous strand of glass without producing splinters in this process which need to be removed subsequently by a washing process. Moreover, such a method or apparatus is to be simple in its arrangement, cost-effective in production and operation, easy to use and flexible.

This object is achieved by the independent claims.

The method in accordance with the invention comprises the following method steps:

1.1 a glass strand is drawn in the direction of its longitudinal axis;

1.2 a heating device is driven synchronously with the glass strand parallel to the same, with the desired separation point being heated;

1.3 the glass strand is stretched in the region of the desired separation point;

1.4 a separation device is moved synchronously with the glass strand and thus parallel to the same;

1.5 the separation device is actuated in such a way that it severs the glass strand at the desired separation point, thus obtaining a tube section or glass tube.

In practice, several ring burners will generally be used as a heating device. It is also possible to use only one single ring burner. Ring burner and separation unit are moved synchronously with the glass strand.

In this way it is possible to produce splinter-free tube sections automatically in 24 hour operation.

### DETAILS OF A PRACTICAL EMBODIMENT

If ring burners are used, their inside diameter as well as their heating zone width are adjusted to the outside diameter of the glass tube, the wall thickness and the separation process. It is possible to provide several types of burners distributed over the entire tube spectrum.

The ring burners are appropriately arranged in such a way that they can be exchanged easily and quickly in the case of a change of product. The individual ring burner is appropriately arranged in the manner of nippers whose two parts enclose the tube strand and which can be swivelled away in order to thread the tube strand into the unit. The burner and the setting of the heating output are controlled by a control device.

In the case of narrow heating zones, lasers will be used as heating devices, especially CO₂ lasers with an annular heating zone.

At the end of the effective path of every heating device there is an infrared sensor which measures the temperature distribution in the axial direction. Temperature signals concerning amplitude, width and time distance of the heating zones can be produced therefrom. The measurement results are used for controlling output and for speed synchronization of the heating devices. The sensor signals are used simultaneously as control signals for the smooth operation of the unit.

Severing can be performed mechanically, e.g. by means of separating shears. The two shearing blades can be tensioned relative to each other. The geometry of the cutting is adjusted to the tube geometry and the path of movement of the knives.

The entire sequence of movement is controlled via a servo control. The cutting force can be limited through springs in order to protect the knives in case of high viscosity of the glass. If necessary, the knives can also be tempered, namely by heating or cooling. For producing open tubes, the cutting process can be arranged in such a way that the tube is not fully closed off.

It is also possible to produce the separation by supplying energy, especially by a burner or laser. By choosing the heating zone width and the type of separating process, it is possible to produce tubes which are open on one side or open on both sides.

It may be appropriate to provide a further laser which produces a CO₂ laser beam for example and which introduces a hole into the thermally softened separating zone during the severing. The laser beam is guided by an optical system which is moved synchronously with the glass strand to the desired position.

Linear Units

The synchronous movement of the burners and the separating unit is realised through linear units which are driven with servomotors via respective controllers (principle of “flying saw”).

The fine setting to the tube drawing speed is performed via an electronic gear, which speed is acquired by an encoder. Speed synchronization is better than 10⁻³.

The starting times of the axes are realised from the output signal of the electronic gear in a counter circuit which allows variable tube lengths.

The maximum synchronous following path of an axis is between approx. 0.50 and 1.20 m, depending on the tube drawing speed and section length.

Tube Guidance

The tube support consists of cylindrical and V-rollers (material is preferably coal) whose circumferential speed is adjusted to the tube speed or whose speed is in excess by approx. 5 to 10% relative to the tube drawing speed in order to allow a discharge of the tubes without having the still hot ends touch each other. Additional V-rollers above the tube ensure the centring of the tube in the centre of the burner. The complementary pairs of rollers give the tube a play perpendicular to the tube axis of a maximum of 1.5 mm. The adjustment of the tube guidance to the different outside diameters occurs fully automatically according to the outside diameter values of the superordinate SPC (stored program control).

Automatic threading of the tube into the unit is realised via tube guide devices which are introduced temporarily into the tube strand.

1-2 additional cylindrical rollers (surface material with a high coefficient of static friction with respect to glass such as silicone, viton) which rest on the tube from above by means of force due to weight or spring force are used for additional acceleration of the tube to be severed in the region of the separation unit and thereafter. The circumferential speed of said rollers is higher by approx. 3 to 15% than the tube drawing speed depending on the severing method. Due to the temperature sensitivity of the material, said rollers are lifted off from the tube in the region of the heating places by means of pneumatic cylinders for example. Alternative devices are possible such as nippers, grippers or chains.

Control

Change between operational states (tube in the shard breaker for service/maintenance and during malfunctions, conventional severing, thermally softened severing).

Definition of burner setting, parameterization of linear axes, setting of tube guidance system, check of system.

A shard breaker is situated upstream of the separating system which keeps the separating system free of the tube in case of strongly fluctuating outside diameters (after the mounting, during malfunctions) and during service work.

Sensors in the course of the tube guidance system are used for checking the tube progress in the system. In the case of malfunctions the shard breaker will be activated.

Blower Control

Suitable control loops for setting the tube geometry must be present in the drawing process, which control loops must be capable of accordingly adjusting the tube geometry in the case of an open tube end (conventional severing) and closed tube end (thermally softened severing) and during changes (e.g. by constant pressure regulation).

The invention is explained on the basis of a block diagram. It shows the schematic structure of an apparatus in accordance with the invention for cutting glass tubes to length in a splinter-free fashion in the drawn tube.

The unit in accordance with the invention is situated in the drawn tube behind the drawing machine which is used for the continuous drawing of the tube.

A shard breaker is situated at the beginning of the unit. It is used to break the tube upstream of the unit if it is outside of the tolerance of the tube guide devices in the unit in order to avoid any damage to the unit through excessive outside diameters for example. In addition it is used for keeping the unit accessible for service and maintenance purposes or in the case of malfunctions. The shard breaker is coupled with a conventional measuring device for outside diameters which supplies the required outside diameter values continuously. The checking of the outside diameter and the triggering of the shard breaker occurs by SPC (stored program control) and by additional security circuits.

The heating units are designed as ring burners which allow a heating of the separation point which is homogeneous over the circumference. The tube is guided by means of suitable tube guide devices in a manner concentrically to the ring burner. The centring ensures a heating which is even over the tube circumference and is necessary both for the cutting quality as well as for achieving a long service life of the knives. Preferably, gas oxygen burners are used. Externally or internally mixing burners can be used depending on the geometry. In order to achieve the highest possible heating rates or end temperatures it is also possible to use hydrogen burners. Principally, all types of burners and also alternative heating methods can be used which ensure a heating of the separation point which is homogeneous over the circumference at a respective heating rate. Alternative heating methods include laser, high-frequency or microwave heating, electrically supported burner heating, etc. The time profile of the heating is controlled via the heating output of the burner and the paths along which the burners travel simultaneously.

The movement of the heating units synchronously to the tube translation occurs by linear units on which the heating units are mounted. The triggering of the controllers of the linear units and the synchronization of the sequentially arranged heating units on the separation point is realized by a superordinate SPC (principle of the “flying saw”). According to the achieved heating output and the available heating time per heating unit one or several identical heating units are arranged sequentially one after the other in order to reach the temperature of approx. 1000° C. which is necessary for the subsequent severing. In order to enable a malfunction-free transition between conventional separation and the thermally softened separation, the start or cut-off of the individual burners and the cutting apparatuses occurs in the manner of a relay race synchronously with the movement of the heating point.

An infrared detector is situated behind each heating unit which detects the temporal position and the axial temperature profile of the heating zone. After the evaluation of the signals, which occurs preferably with a signal processor, the information on the position and the speed correction of the heating units are derived. The speed is fine-tuned by the correction of a master frequency which is gained from the drawing machine for example. The fine-tuning is necessary because the master frequency usually only reflects the tube drawing speed with a precision in the percent range. The speed error is time-dependent through wear and tear of the drawing apparatus or through changing slip during changes in the temperature. Direct, continuous measurements of the current tube drawing speed would lead to highly prohibitive costs.

Once the separation zone has reached the required temperature, the tube portion to be severed is accelerated relative to the tube drawing speed by up to 10%. In this way a tapering of the tube and a reduction of the wall thickness in the zone of the separation point is achieved, namely with the following advantages:

Improved tube end quality

Reduction of the stress on the knife during the subsequent severing processing

Enabling of a high severing speed (advancing time of the knife<approx. 100 ms)

Reduction of the time for the introduction of a venting hole in the thermally softened zone

The acceleration of the tube portion to be severed occurs by an additional pressure roller which is lifted off from the tube by means of a suitable mechanism in the zone of the hot tube ends in order to prevent the degeneration of the roller coating in contact with the tube ends which still have a hot temperature in the region of approx. 1000° C.

In addition, the separation of the severed tube ends is secured through the accelerated movement.

The severing of the tube in the zone of the heated, plastically deformable zone occurs in a cutting process with a knife construction in which the movement of the knife is realised through a servo-motor within an optimised path-time profile. The cutting knives are coupled with the drive via a spring mechanism. This elastic coupling allows both a continuous, qualitative measurement of the glass viscosity in the zone of the separation point over the current cutting speed. These values are used in the SPC for checking and optimising the heating process. On the other hand, the likelihood of damaging the knives during any malfunction of the unit is reduced.

In order to prevent the formation of a negative pressure in the tube during the cooling (during the severing process the entrance temperature of the tube into the unit is approx. 100 to 400° C.) and the thus ensuing problems in the further processing of the severed tube pieces, a venting hole is introduced in the hot state. Preferably, this occurs synchronously (only locally offset) to the severing process, because in this case the linear axis of the severing tool can also be used for entraining the hole burning tool. In the unit in accordance with the invention this introduction of the venting hole occurs by means of a focused CO₂ laser beam. Only one deflection mirror and one motively adjustable focusing optical system are entrained on the linear axis. The laser parameters are set in such a way that the introduction of the hole occurs in <500 ms, according to the available synchronous entrainment time.

Additional sensor systems are used for checking the successful introduction of the venting hole. Such checking is essential because the splinter-free further processing of the tube can generally not be guaranteed without the venting hole. Causes for a lack of venting holes can be malfunctions in the process of glass faults. The checking of the venting hole advantageously occurs during the introduction of the same by the detection of the heating of the side of the tube opposite of the hole by the CO₂ laser beam. As a result of the low absorption length of the laser beam, a heating of the opposite tube side only occurs after the hole has been burnt through. Proof of heating the opposite tube side occurs for example by a photo-detector in the visible or IR range whose field of visibility is limited by an aperture on the opposite tube side in order to suppress portions of reflected or scattered light from the hole side. Alternatively, the use of CMOS or CCD cameras with subsequent picture evaluation is possible. Moreover, the evaluation of the luminous phenomenon (plasma) during the burning of the hole or the change in the reflection of the CO₂ laser beam is possible for proving the formation of the hole. Due to the erratic tube position, such methods show low sensitivity. One advantage of direct observance is the possibility of switching off the laser beam directly after burning the hole. In this way the formation of evaporation products and a possible condensation in the tube is reduced.

The detection of the venting hole is also possible in the further process by optical methods for example in the visible and adjacent spectral regions. In addition to the direct detection of the hole, it is also possible to evaluate the change of the shape of the tube end which is produced by the formation of a negative pressure and the thus resulting “drawing in” of the tube ends when there is no venting hole, which tube ends still show low viscosity after the separation.

Tubes without a venting hole are usually sorted out by means of a sorting apparatus which is usually present.

The removal of the tubes for further processing occurs by actively driven supporting rollers with a speed which is approx. 10% higher than the tube drawing speed in order to avoid any contact of the tube ends. The further processing of the tubes occurs under suitable ambient conditions (e.g. clean room, laminar flow box, . . . ) in order to prevent any later soiling during the venting of the tubes.

### DRAWING

Tube drawing Superordinate SPC SPC Operational control unit Speed Drive and Burner, controlling Laser synchronization control units and automatic controlling unit

Drawing machine

Shard breaker

Measuring device for outside diameter

Heating unit 1

Temperature sensor 1

Heating unit I

Temperature sensor I

Separation unit

Transport unit

FIG. 1: Schematic layout of an apparatus for cutting glass tubes to length in a splinter-free fashion in drawn tubes

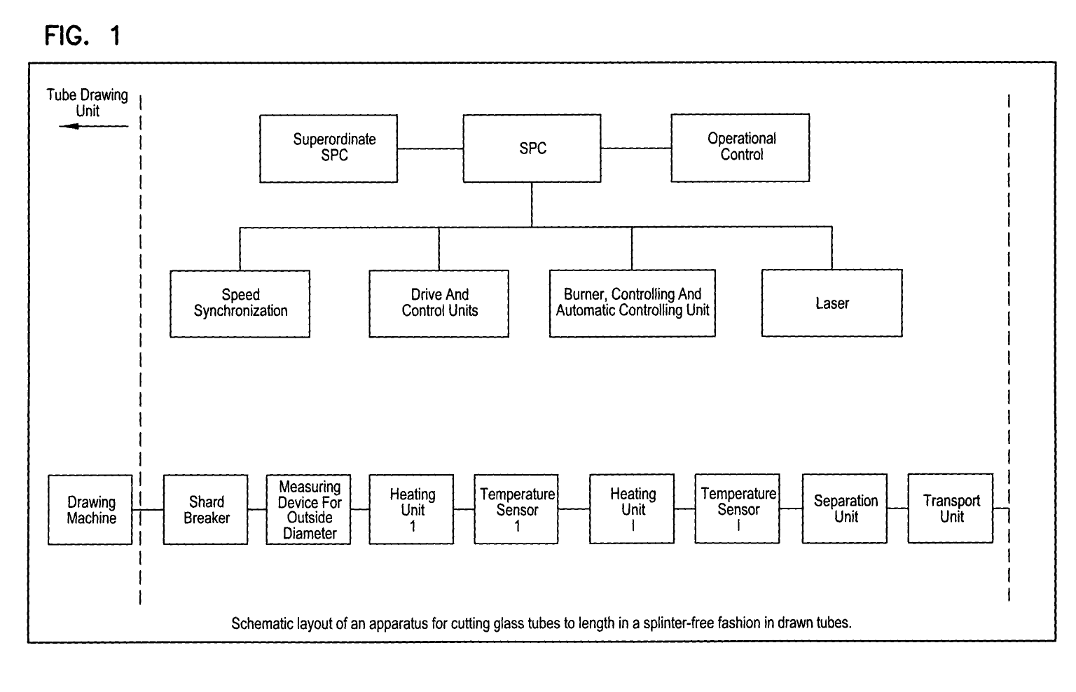

1. A method for cutting glass tubes to length, comprising the following method steps:
a glass strand is drawn;
a heating device is driven synchronously with the glass strand and is directed towards the region of a desired separation point;
the glass strand is drawn in the region of the desired separation point;
a separation device is driven synchronously with the glass strand;
the separation device is actuated in such a way that it severs the glass strand at the desired separation point;
a hole is burnt into the thermally softened separation point of the glass strand.

2. A method as claimed in claim 1, characterized in that a laser beam is used for burning the hole.

3. An apparatus for cutting glass to length, comprising:
a conveying device for conveying and guiding the glass strand;
a heating device which can be moved together with the glass strand and can be directed towards the region of a desired separation point;
a device for stretching the glass strand on its conveying path;
a separation device which can be moved together with the glass strand;
an actuator for actuating the separation device upon reaching the required processing temperature;
a laser device is provided for burning a hole into the thermally softened region of the glass strand.

4. An apparatus as claimed in claim 3, characterized in that a device for proving the formation of the hole is provided.

5. An apparatus as claimed in claim 3 or 4, characterized in that the heating device comprises at least one ring burner.
